(19) United States
(12) Patent Application Publication
(10) Pub. No.: US 2019/0063022 A1
(43) Pub. Date: Feb. 28, 2019

(54) MATERIAL CONTAINMENT AND TRANSPORT DEVICE

(71) Applicant: Jennifer Diane Granger, Brooklyn, NY (US)

(72) Inventor: Jennifer Diane Granger, Brooklyn, NY (US)

(21) Appl. No.: 15/692,102

(22) Filed: Aug. 31, 2017

(51) Int. Cl. E01H 5/06

(52) U.S. Cl. CPC E01H 5/065; B62D 63/061

(57) ABSTRACT

A material containment and transport device may be provided. The material containment and transport device includes a body portion having opposed body side edges and opposed body end edges connecting respective ends of the body side and end edges. The containment and transport device includes a border portion constructed of a porous mesh material, the border portion having at least a pair of border side edges and a plurality of opposed border end edges connecting respective ends of respective border side edges. The border portion outwardly surrounds the body portion. At least one pull cord is selectively attached to and extends away from a corner of the border portion so that the body portion may be pulled thereby.

### BACKGROUND OF THE INVENTION

The present invention relates to material containers and, more particularly, to a material containment and transporting device that is adapted to collect a quantity of snow and be pulled by a vehicle to a disposal or melting area.

The accumulation of snow on a residential sidewalk can be a significant impediment for residents needing to walk in and out of their home. When snow is deep clearing it with a shovel or just waiting on it to melt can be a significant burden. Various devices are known for removal of snow, such as snow blowers and tractors with blades; however, owning and maintaining such devices for seasonal usage in times of snow accumulation is expensive.

As can be seen, there is a need for a material containment and transport device that may be positioned atop a sidewalk or a ground surface and be adapted to collect snow, preventing snow from accumulating on the sidewalk itself. Further it would be desirable to have a material containment and transport device that may be pulled away from the location where snow has been collected thereon and moved to a location wherein it may be piled up, disposed of, or otherwise left for melting.

### SUMMARY OF THE INVENTION

A material containment and transport device according to the present invention includes a body portion having opposed body side edges and opposed body end edges connecting respective ends of the body side and end edges. The containment and transport device includes a border portion constructed of a porous mesh material, the border portion having at least a pair of border side edges and a plurality of opposed border end edges connecting respective ends of respective border side edges. The border portion outwardly surrounds the body portion. At least one pull cord is selectively attached to and extends away from a corner of the border portion so that the body portion may be pulled thereby.

Therefore, a general object of this invention is to provide a material containment and transport device that may be positioned on a sidewalk, driveway, or ground surface for collecting falling snow.

Another object of this invention is to provide a material containment and transporting device, as aforesaid, that may be hooked up to a motor vehicle and pulled to another location for disposal.

In one aspect of the present invention, a material containment and transporting device includes an elastic body portion having opposing upper and lower surfaces; a mesh border portion circumscribing the body portion along peripheral edges thereof, the mesh border portion having a pair of opposing border sides extending between opposing border ends; and a reinforced corner aperture provided by each border side.

In another aspect of the present invention, method of removing accumulated snow from a surface, including the steps of: placing the material containment and transporting device on said surface; connecting a pull cord to each reinforced corner aperture; attaching a distal end of each pull cord to a vehicle; and subjecting each pull cord to an axial load via the vehicle so that the device of claim 1 forms a volumetric C-shape.

In yet another aspect of the present invention, the material containment and transporting device includes an elastic non-porous body portion having opposing upper and lower surfaces; a PVC layer provided by and coextensive with the upper surface; a mesh border portion circumscribing the body portion along peripheral edges thereof, the mesh border portion having a pair of opposing border sides extending between opposing border ends; a corner aperture provided by each border side, wherein each corner aperture is reinforced with a non-mesh material; and one or more pull chords connected to one or more of said reinforced corner apertures, wherein the device is adapted to form a volumetric C-shape when a pull cord connected to each corner aperture is subjected to an axial loading.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is an isolated perspective view of an exemplary embodiment of a body portion of the present invention;

FIG. 4 is an isolated perspective view of an exemplary embodiment of the body portion of the present invention, illustrated in a flexed use configuration;

FIG. 5 is a perspective view of an exemplary embodiment of the present invention, illustrated in a flexed use configuration;

FIG. 6a is an isolated perspective view of an exemplary embodiment of a pull cord of the present invention;

FIG. 6b is an isolated view of an enlarged scale taken from 6a;

FIG. 6c is an isolated view of an enlarged scale taken from 6a;

FIG. 7 is a perspective view of an exemplary embodiment of the present invention, illustrating the pulled cord coupled to a corner thereof;

FIG. 7a is an isolated view of an enlarged scale taken from 7;

FIG. 7b is an isolated view of an enlarged scale taken from 7;

FIG. 8a is a top view of an exemplary embodiment of the present invention, coupled to a vehicle with at least a pair of pull cords;

FIG. 8b is a side view of an exemplary embodiment of the present invention coupled to a vehicle with at least a pair of pull cords;

FIG. 9 is a perspective view of an exemplary embodiment of the present invention coupled to a vehicle with two pairs of pull cords for forming the flexed use configuration; and

FIG. 10 is a perspective view of an exemplary embodiment of the present invention, connected to a vehicle in an alternative configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a material containment and transport device adapted to assume a volumetric C-shaped flexed use configuration. The material containment and transport device includes a body portion having opposed body side edges and opposed body end edges connecting respective ends of the body side and end edges. The containment and transport device includes a border portion constructed of a porous mesh material, the border portion having at least a pair of border side edges and a plurality of opposed border end edges connecting respective ends of respective border side edges. The border portion outwardly surrounds the body portion. At least one pull cord is selectively attached to and extends away from a corner of the border portion so that the body portion may be pulled thereby.

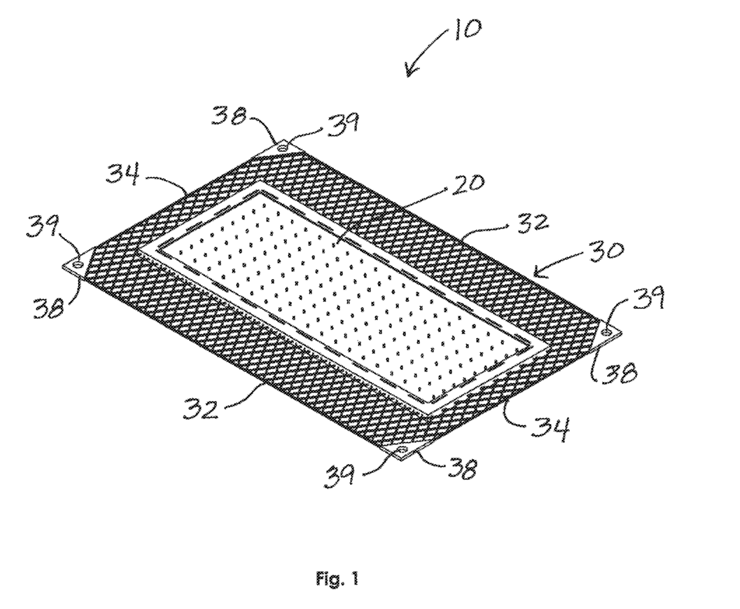

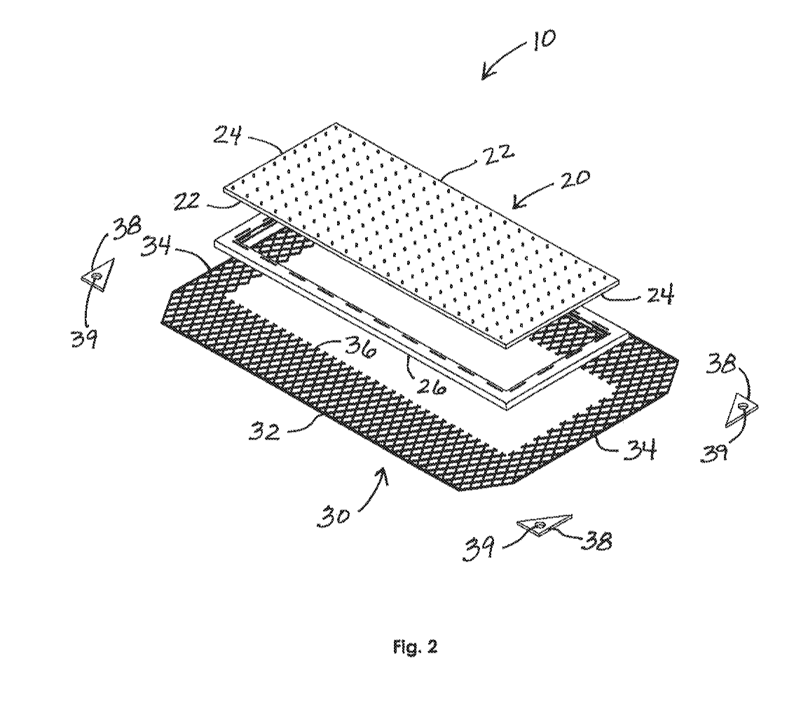

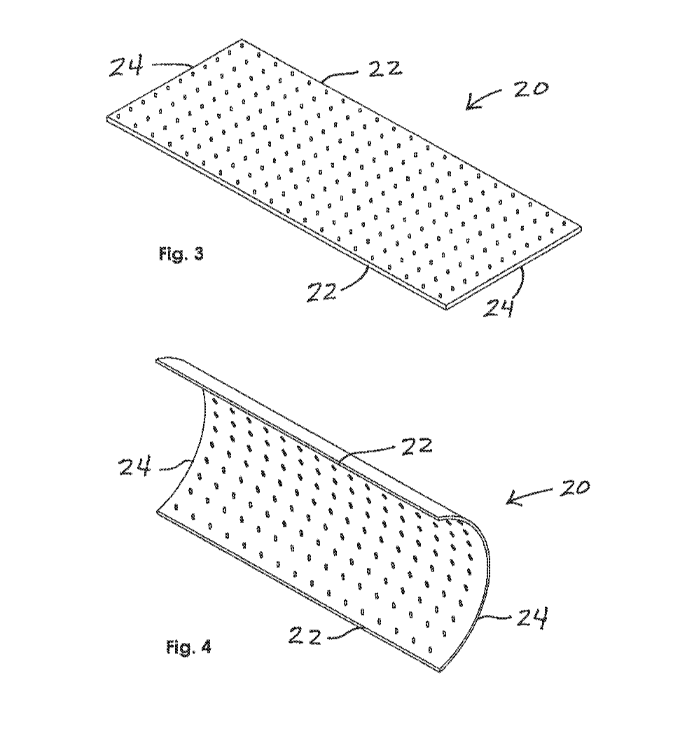

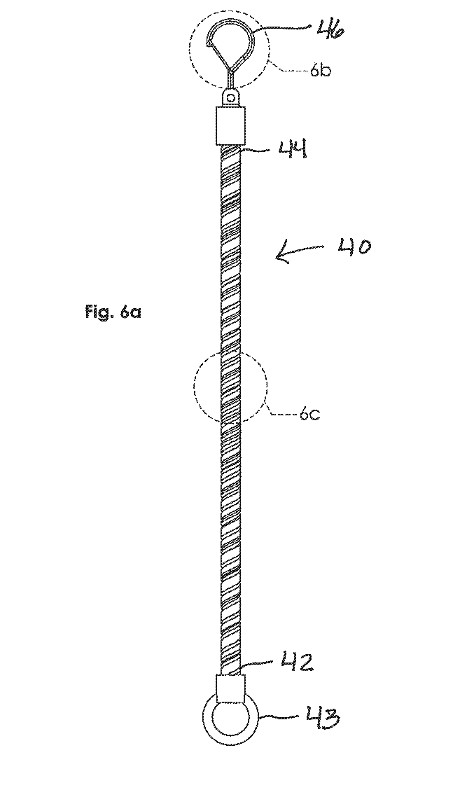

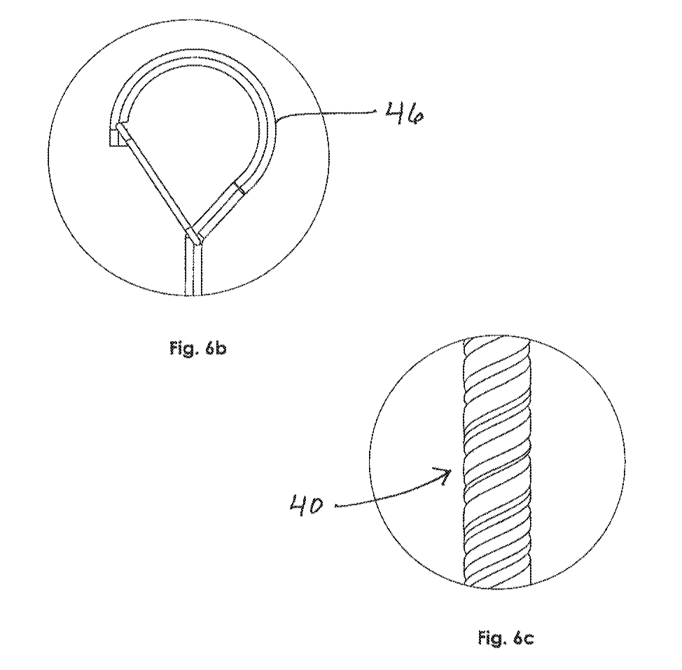

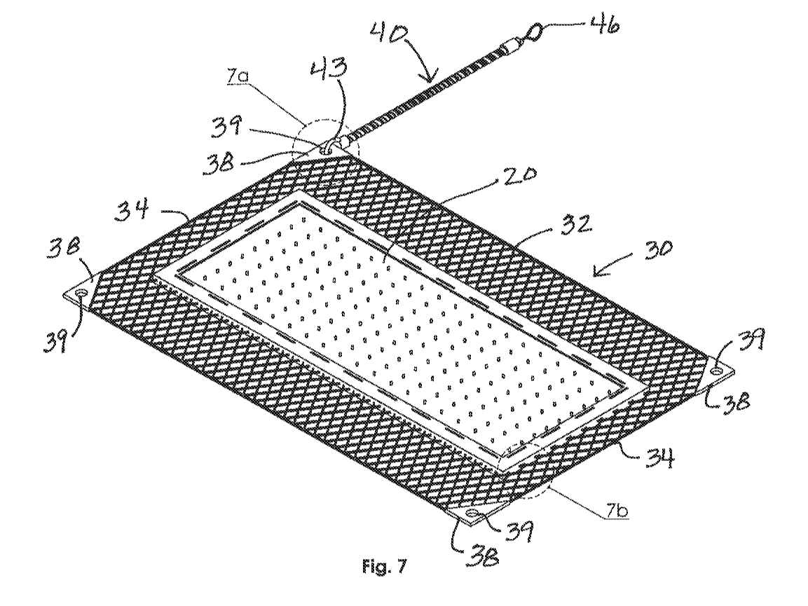

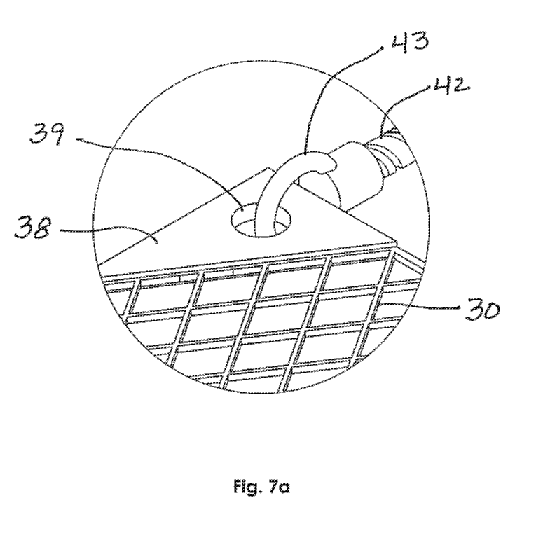

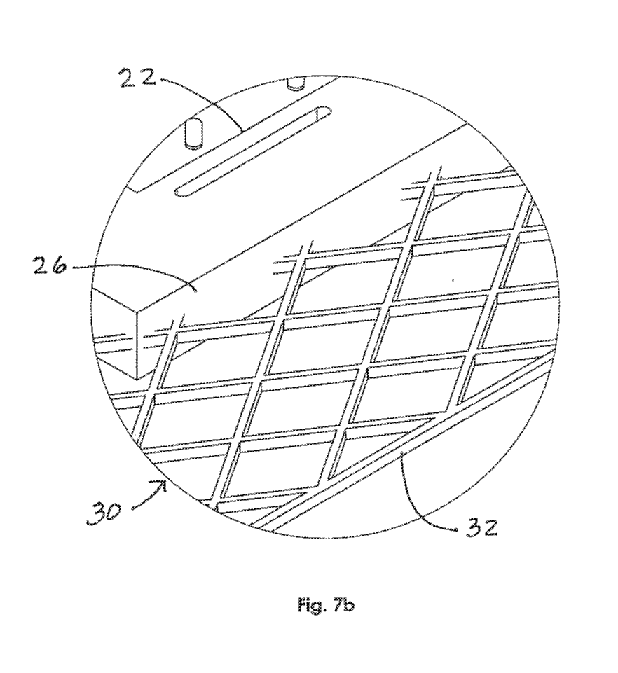

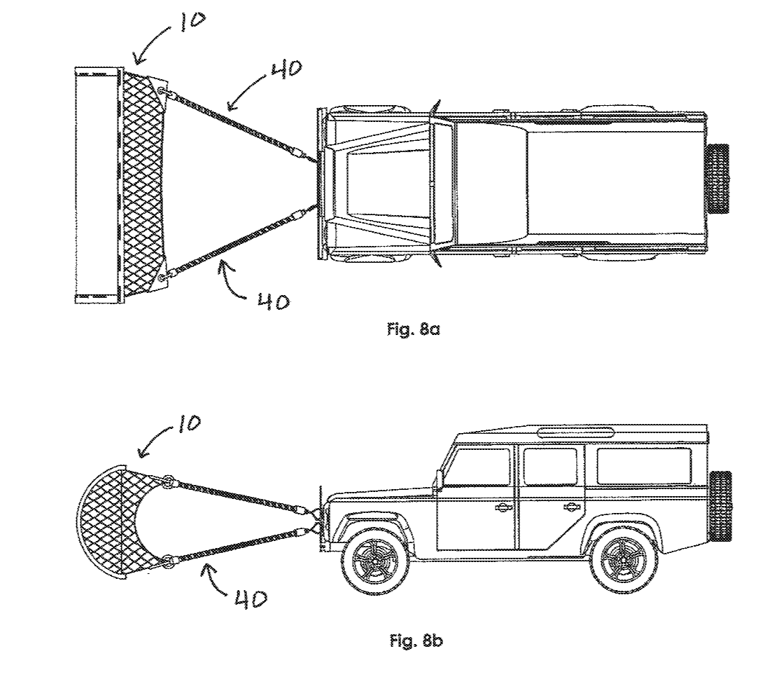

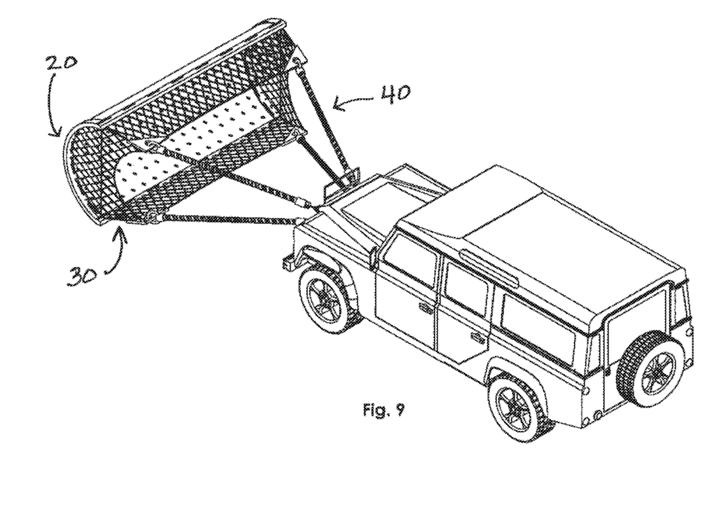

Referring to FIGS. 1 through 10, the present invention may include a material containment and transport device 10 having a body portion 20 surrounded by a border portion 30 and one or more pull cords 40 configured to pull the entire transport device 10 manually by a person or, most likely, when attached to a motor vehicle such as an all-terrain vehicle (ATV) or truck, so as to pull the material (e.g., snow) contained on the device to a disposal location.

The material containment and transport device 10 includes a body portion 20 having a planar configuration and constructed of a non-porous elastic material that is lightweight yet durable. The elastic material may include an upper surface or be coated with polyvinyl chloride (PVC) polyester. The elastic lower surface may be skid resistant and abrasion resistant. In the embodiment, the body portion 20 includes a pair of opposed and parallel body side edges 22 extending between a pair of opposed body end edges 24. In this embodiment, the body portion has a generally rectangular shape configuration although it is understood that other shape configurations would be suitable, such as circular, oval or trapezoidal configurations.

The border portion 30 may be constructed of porous mesh material, such as twisted knotted nylon barrier netting, whereby in an unused condition along a supporting surface the boarder portion 30 assumes the contour of the supporting surface—for example, on flat ground the border portion has a planar configuration. More particularly, the border portion 30 may include a pair of opposed border sides 32 extending to a pair of opposed border end edges 34. The border portion 30 may be coupled to the body portion 20 along the latter's ends and side edges so as to circumscribe the body portion 20 enabling the border portion 30 to be in the same horizontal plane therewith. However, the body portion 20 and border portion 30 are flexible such that they are moveable in position not have a common plane as will be described further later. In other embodiments, the body portion 20 defines an outer peripheral edge 26 and the border portion 30 defines a continuous inner peripheral edge 36 that is coupled to said outer peripheral edge such as by sewing, heat sealing, or other joining mechanisms. Thus, the border portion can be seen to surround the body portion 20.

In one embodiment, the border portion 30 includes a plurality of corners 38 naturally formed by intersection of respective border side and end edges (FIG. 1). The corners 38 may be reinforced construction, such as with leather sewn or otherwise coupled to the mesh material. One or more reinforced corners 38 may define an aperture 39 to which a pull cord 40 may be selectively coupled as will be described below.

The material containment and transport device 10 includes at least one or more pull cords 40 by which to pull a load of accumulated material collected atop the body portion 20. A pull cord 40 may have an elongated configuration having a proximal end 42 selectively coupled to a respective reinforced corner 38 and an opposed distal end 44 extending away from the first end. The pull cord 40 may include sturdy twine or, alternatively, be a cable or chain. The pull cord 40 may be about five feet in length. In one embodiment, a plurality of pull cords 40 may be included—one coupled to each corner 38 with a first fastener 43 adjacent to the proximal end 42 such as a hook, carabiner, ring, clasp, or other quick connect hardware. A similar second fastener 46 may be coupled to the distal end 44 for selectively coupling the pull cord 40 to a vehicle to be used to pull the containment and transport apparatus 10.

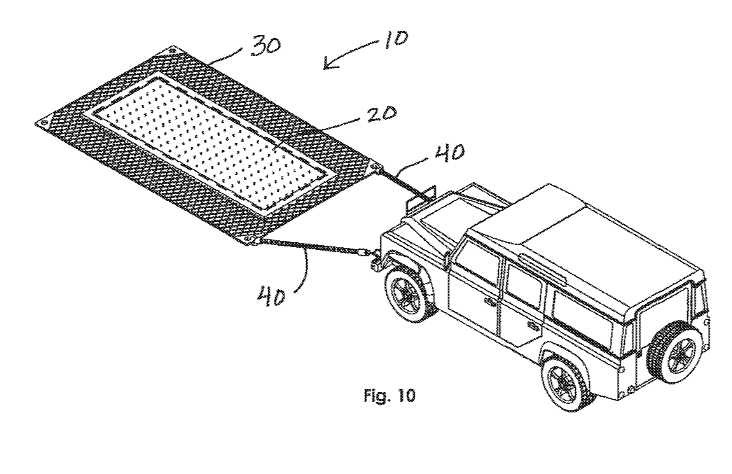

In use, the material containment and transport device 10 may be positioned on the ground at a location where material is intended to be collected and where it is desired to keep that material from accumulating on the ground itself. For instance, a residence may position the device 10 on a sidewalk where it is desired to keep snow from accumulating. Then when snow falls, it accumulates on the body portion 20 rather than on the ground. When the snow event ends, one or more of the pull cords 40 may be coupled to a motorized device, such as an ATV, truck, or even a riding lawn mower and pulled away to a remote location where it may be dumped or just allowed to wait on warmer temperatures to induce melting. As shown in FIG. 10, a pair of pull cords 40 may be coupled to the material containment and transport device 10 along one side or one end for pulling the device 10 in a sideways direction, or endways direction.

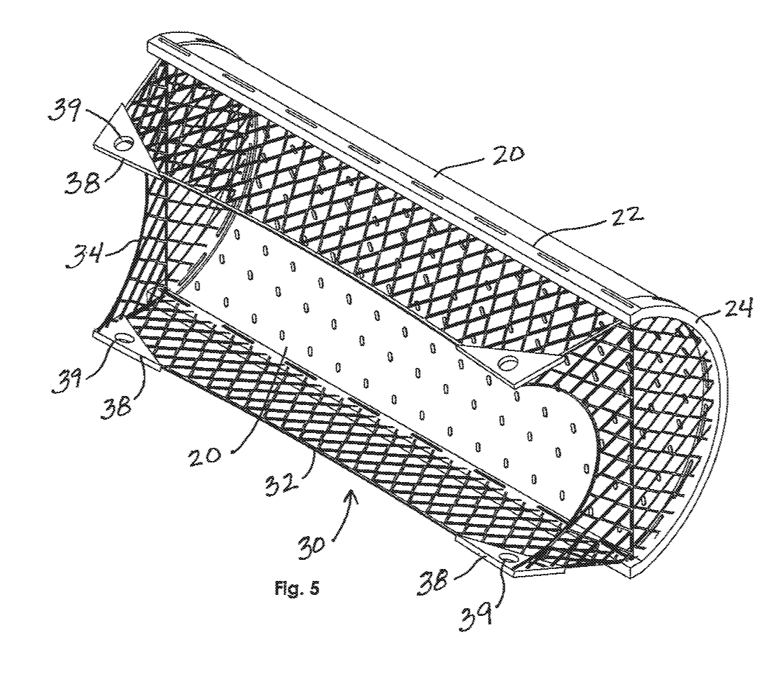

As illustrated in FIGS. 5, 8a, 8b, and 9, the present invention may be coupled to four pull cords 40, one such pull cord 40 at each corner 38 so that in a used condition the device 10 defines a flexed use configuration. In the flexed use configuration, under the pull cord-imposed axial tension provided through the border and body sides 32 and 22, respectively, each body edge 24 forms a C-shape, urging the opposed border ends 34 to each form a C-shape, as illustrated in FIG. 5. Thus, the axially extended border edges and sides 34 and 32 defines a volumetric C-shape of the flexed use configuration. The flexed use configuration is facilitated by the corner apertures 39 being spaced apart along the border side within the border side edges. Moreover, the flexibility of the mesh border portion 30 allows it to pivot relative to the body portion 10 about the peripheral edge thereof.

It should be understood, of course, that the foregoing relates to exemplary embodiments of the invention and that modifications may be made without departing from the spirit and scope of the invention as set forth in the following claims.

What is claimed is:

1. A device, comprising:
an elastic body portion having opposing upper and lower surfaces;
a mesh border portion circumscribing the body portion along peripheral edges thereof, the mesh border portion having a pair of opposing border sides extending between opposing border ends; and
a reinforced corner aperture provided by each border side.

2. The device of claim 1, further comprising a PVC layer provided by and coextensive with the upper surface.

3. The device of claim 1, wherein each reinforced corner aperture is reinforced with a non-mesh material.

4. The device of claim 1, wherein the body portion is non-porous.

5. The device of claim 1, further comprising one or more pull chords connected to one or more of said reinforced corner apertures.

6. The device of claim 5, wherein the device is adapted to form a volumetric C-shape when a pull cord connected to each reinforced corner aperture is subjected to an axial loading.

7. A device, comprising:
an elastic non-porous body portion having opposing upper and lower surfaces;
a PVC layer provided by and coextensive with the upper surface;
a mesh border portion circumscribing the body portion along peripheral edges thereof, the mesh border portion having a pair of opposing border sides extending between opposing border ends;
a corner aperture provided by each border side, wherein each corner aperture is reinforced with a non-mesh material; and
one or more pull chords connected to one or more of said reinforced corner apertures,
wherein the device is adapted to form a volumetric C-shape when a pull cord connected to each corner aperture is subjected to an axial loading.

8. A method of removing accumulated snow from a surface, comprising the steps of:
placing the device of claim 1 on said surface;
connecting a pull cord to each reinforced corner aperture;
attaching a distal end of each pull cord to a vehicle; and
subjecting each pull cord to an axial load via the vehicle so that the device of claim 1 forms a volumetric C-shape.

9. A method of removing accumulated snow from a surface, comprising the steps of:
placing the device of claim 1 on said surface;
connecting a pull cord to two adjacent reinforced corner apertures;
attaching a distal end of each pull cord to a vehicle; and
subjecting each pull cord to an axial load via the vehicle so that the device of claim 1 slides along the surface.
